(19) United States
(12) Patent Application Publication
(10) Pub. No.: US 2004/0119872 A1
(43) Pub. Date: Jun. 24, 2004

(54) Light quantity adjustment cover, imaging device and imaging device mounting method

(75) Inventors: Takashi Ichikawa, Saitama (JP); Fumiyoshi Nishimura, Saitama (JP); Seigo Nakai, Saitama (JP)

Correspondence Address: FOLEY AND LARDNER, SUITE 500, 3000 K STREET NW, WASHINGTON, DC, 20007, US

(73) Assignee: TAMRON CO., LTD.

(21) Appl. No.: 10/703,543

(22) Filed: Nov. 10, 2003

(30) Foreign Application Priority Data
Dec. 19, 2002 (JP) 2002-368978

(51) Int. Cl. H04N 5/235; G03B 7/00; H04N 5/225

(52) U.S. Cl. 348/360; 348/375

(57) ABSTRACT

When an imaging device is mounted, a light quantity adjustment cover that adjusts a quantity of incident light into the imaging device is fit to the imaging device. The light quantity adjustment cover may be made of synthetic resin. The light quantity adjustment cover can be attached to and detached from the imaging device. Accordingly, before the imaging device is mounted, the imaging device can be protected, and after the imaging device is mounted, it can easily be detached.

### BACKGROUND OF THE INVENTION

1) Field of the Invention

The present invention relates to an imaging device, especially surveillance imaging device such as a surveillance camera or a surveillance television camera having an image pickup device such as a charge coupled device (hereinafter, “CCD”) or a complementary metal oxide semiconductor (hereinafter, “C-MOS”).

2) Description of the Related Art

In recent years, imaging devices such as surveillance cameras and surveillance television cameras are installed on many locations for crime prevention. Operations required for installing an imaging device indoor or outdoor is normally carried out during daylight hours. What is important at that time is an adjustment of the imaging device for obtaining excellent image. This adjustment is carried out by adjusting a shooting lens of the imaging device in accordance with a distance to a target object, and by setting an optimal focus position (back focus). Concretely, an image of the target object on a television monitor is visually observed, and a focus position where the image is optimally resolved is set.

An auto bright iris is normally contained in the imaging device in many cases. The auto bright iris takes a light quantity (exposure amount) passing through a shooting lens of the imaging device and light receiving sensitivity of an image pickup device such as the CCD, C-MOS or the like into consideration, and automatically determines an aperture diameter (from maximum aperture diameter to minimum aperture diameter). When the light quantity passing through the shooting lens of the imaging device is great (bright), the auto bright iris sets its aperture diameter to a value close to the minimum value. When the light quantity passing through the shooting lens of the imaging device is small (dark), the auto bright iris sets its aperture diameter to a value close to the maximum value.

In order to obtain an optimal image, the shooting lens of the imaging device must always adjust the focus in accordance with the size of the aperture of the auto bright iris. When the imaging device is adjusted during the daylight hours, the aperture of the auto bright iris is set to a value close to the minimum value. The focus position at which the optimal image is obtained is searched by the size of the aperture of the auto bright iris, and the shooting lens is adjusted such that the back focus position comes on a surface of the image pickup device. That is, the adjustment of the surveillance camera is completed when the aperture diameter of the auto bright iris becomes the minimum value and the back focus position becomes long (over side).

Conventionally, there exists imaging devices having no lens cap for protecting flaws and contamination and no function for adjusting the incident light quantity (For example, see Japanese Patent Application Laid-open Publication No. H8-136977, Japanese Patent Application Laid-open Publication No. H10-268383, and Japanese Patent Application Laid-open Publication No. 2000-305130).

However, the imaging device is operated more frequently during daylight hours than during nighttime hours, and if an attempt is made to mount the imaging device during dark nighttime hours, it is difficult to see the mounting place or parts to be mounted, and the mounting operation of the imaging device is more difficult as compared with that during the daylight hours. Therefore, it takes time and labor for the mounting operation.

During the nighttime operation, it is possible to illuminate the mounting position using electric lights to create a bright condition, but the electric lights are comparatively darker than the natural brightness of daylight, and sufficient brightness of such a degree that the mounting operation is not hindered at all cannot be provided. Therefore, if the mounting operation is continued under such condition, like the above condition, the mounting operation is difficult and it takes time and labor. Further, since the mounting operation is carried out in a somewhat fumbling state, the imaging device and the mounting position cannot be connected to each other properly, and consequently the imaging device may fall onto ground, causing a failure or damage in some cases. For these reasons, it is preferable that the mounting operation of the imaging device is carried out during daylight hours.

On the other hand, when the shooting lens of the imaging device is adjusted using the aperture diameter which is suitable for shooting in a bright condition during daylight hours, it is difficult to obtain a depth of field which is suitable for night shooting. When the imaging device which is adjusted during daylight hours is operated during nighttime, there is an adverse possibility that the focus position of the shooting lens is deviated. Thus, a picture is taken during nighttime using the imaging device which is adjusted during daylight hours, a quality of the obtained image is deteriorated in some cases.

For amateur or even for professional, if he or she lacks experience, in order to set a diaphragm or focus which is optimal for night shooting in a bright condition such as daylight hours, operation must be repeated many times until the diaphragm or focus is adjusted to the optimal value, and it takes a great deal of time and labor. It is possible for a skilled person to optimally adjust the diaphragm value and focus depending upon experience or guesswork, but even for such a skilled person, he or she must repeat the operation several times to adjust the diaphragm value and focus while assuming the night shooting during daylight hours in some cases, and it takes time and labor for the adjustment. Thus, it is extremely difficult to set the diaphragm value and the focus suitable for the nighttime shooting by one trial irrespective of the degree of skill of the operator.

When out-of-focus is found or generated after the mounting operation is completed, in order to adjust the focus again, a user must again request the mounting operator of the imaging device, and it takes a great deal of time and labor for the mounting operation.

Especially since the mounting operation is carried out during the daylight hours, time when the out-of-focus is found or generated is at night of the same day at earliest. Therefore, if the user requests the mounting operator from that time, the time when the mounting operator can adjust again is next day of the mounted day or after, and it takes several days until the mounting operation is completed. Thus, the user can not shoot nighttime until the readjustment is completed, and this is a problem for crime prevention.

### SUMMARY OF THE INVENTION

It is an object of the present invention to at least solve the problems in the conventional technology.

A light quantity adjustment cover according to one aspect of the present invention includes an arrangement with which a quantity of incident light to an imaging device can be adjusted when the imaging device is set.

A imaging device according to another aspect of the present invention includes a light quantity adjustment cover fit to an opening from where light enters into the imaging device, wherein the light quantity adjustment cover includes an arrangement with which a quantity of light entering into the imaging device can be adjusted when the imaging device is set.

An imaging device mounting method, according to still another aspect of the present invention, of mounting an imaging device in which a quantity of incident light into the imaging device can be adjusted by means of a light quantity adjustment cover, includes adjusting the quantity of incident light into the imaging device by adjusting at least one of diaphragm or filter of the imaging device.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a schematic perspective view of an imaging device of the present invention;

FIG. 2 is a partially enlarged side view of the imaging device of the invention;

FIGS. 3A and 3B are respectively schematic perspective view and side sectional view of a lens cap as a light quantity adjustment cover of the invention;

FIG. 4 is a flowchart illustrating an execution procedure of an imaging device mounting method of the invention;

FIG. 5 illustrates a mounted state of the imaging device when the lens cap is used as the light quantity adjustment cover of the invention;

FIG. 6 is a partial side view of the imaging device on which the lens cap of the invention is mounted;

FIGS. 7A and 7B are respectively schematic perspective view and side view of a pasting sheet as the light quantity adjustment cover of the invention, and FIG. 7C illustrates the mounted state of the imaging device when the pasting sheet is used; and

FIGS. 8A and 8B are front views of a lens-barrel when an opening/closing mechanism is applied as the light quantity adjustment cover.

### DETAILED DESCRIPTION

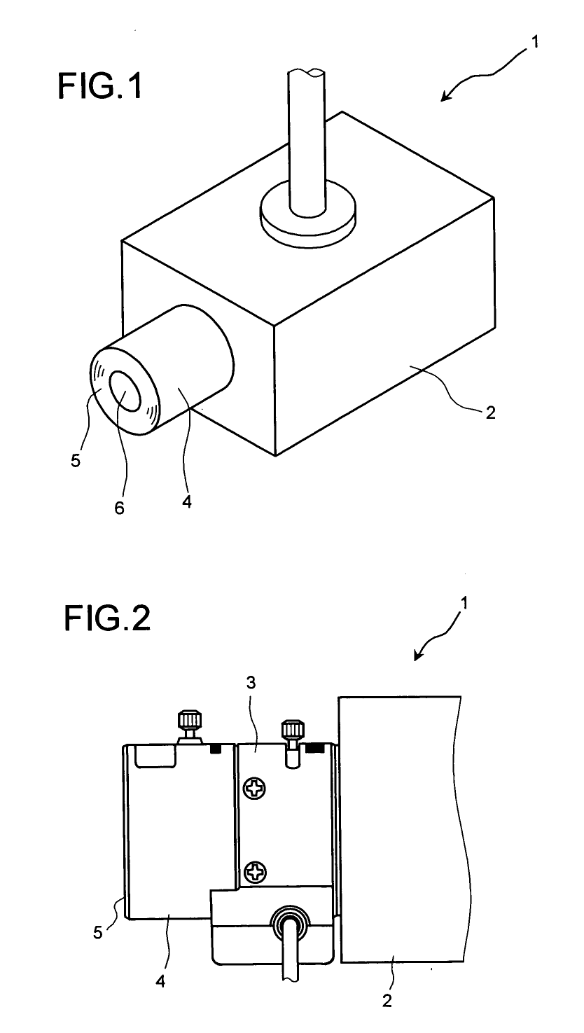

Exemplary embodiments of the present invention will be explained below in detail. FIG. 1 is a schematic perspective view of an imaging device 1. The imaging device 1 is a surveillance camera or a surveillance television camera for example. As illustrated in FIG. 1 and FIG. 2, the imaging device 1 includes an image pickup device (not illustrated) such as a CCD or C-MOS, a device body 2, an auto iris 3 and a lens-barrel 4. The imaging device 1 is provided with an incident opening 6. The incident opening 6 is an opening 6 formed in a tip end 5 of the lens-barrel 4. A shooting lens (not illustrated) is held in the lens-barrel 4. The shooting lens receives incident light into the lens-barrel 4 and lead the light into the image pickup device.

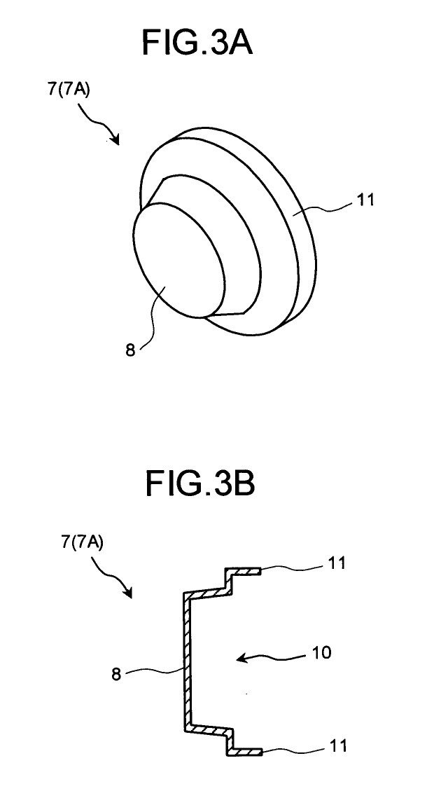

A light quantity adjustment cover of this embodiment will be explained. The light quantity adjustment cover 7 adjusts a quantity of incident light into the imaging device 1 when the imaging device 1 is mounted. As illustrated in FIGS. 3A and 3B, the light quantity adjustment cover 7 of this embodiment includes a lens cap 7A. An axial one end of the lens cap 7A is a closed cap surface 8, and the other end is an open end 10. The cap surface 8 is a circular flat surface, and its diameter is set greater than that of the shooting lens projecting from the lens-barrel 4. An attaching/detaching section 11 is bent and formed on a periphery of the open end 10 of the lens cap 7A. The attaching/detaching section 11 can be attached to and detached from the tip end 5 of the lens-barrel 4. An inner diameter of the attaching/detaching section 11 is approximately equal to an outer diameter of the tip end 5 of the lens-barrel 4. With this design, the lens cap 7A can be attached to and detached from the tip end 5 of the lens-barrel 4.

The lens cap 7A is made of synthetic resin such as plastic. A thickness of the cap surface 8 of the lens cap 7A is preferably about 0.3 to 0.4 millimeter. With this design, an inexpensive lens cap 7A can be provided. If the lens cap 7A is inexpensive, it may be a disposable type.

When the lens cap 7A is made of synthetic resin, dyes may be applied to the lens cap 7A so that the lens cap is colored and transparent. Color of the dyes is preferably black. With this design, the quantity of light in visible region which passes through the cap surface 8 can uniformly be cut off, and the lens cap includes the same function as a neutral density filter (hereinafter, “ND filter”). The lens cap 7A can be used for any of color shooting and monochrome shooting.

Therefore, if the lens cap 7A is mounted on the tip end 5 of the lens-barrel 4, it is possible to suppress the incident light quantity to the shooting lens of the imaging device 1, and even during bright daylight hours, it is possible to create the same environment as that of the nighttime shooting. As a result, if the lens cap 7A is used, even when the imaging device 1 is adjusted during bright daylight hours, it is possible to precisely adjust the focus with nighttime shooting in mind.

A question as to how much the incident light quantity to the shooting lens of the imaging device 1 should be suppressed to set the same environment as the nighttime shooting can not be determined constantly because the incident light quantity to the shooting lens is varied depending upon the mounting position of the imaging device 1 and various conditions such as weather. In order to meet various conditions, it is preferable that a plurality of kinds of lens caps 7A having different cut ratios of the transmission light quantity are prepared. Accordingly, it is possible to adjust the surveillance camera more precisely.

In this invention, the lens cap 7A is made of synthetic resin and a thickness of the cap surface 8 which is opposed to the shooting lens when the lens cap 7A is mounted to the tip end 5 of the lens-barrel 4 is set to about 0.3 to 0.4 millimeter. The lens cap 7A is formed such that the lens cap comes into intimate contact with the tip end 5 of the lens-barrel 4 when the lens cap 7A is mounted to the lens-barrel 4. The lens cap 7A also has a function for protecting the shooting lens against dust and damage like a general lens cap.

Since the lens cap 7A of the invention is made of synthetic resin which can be processed easily, the lens cap is inexpensive. However, if the cost is not a problem, the lens cap 7A of the invention may be made of another material only if the lens cap 7A has the suppressing function of the transmission light quantity.

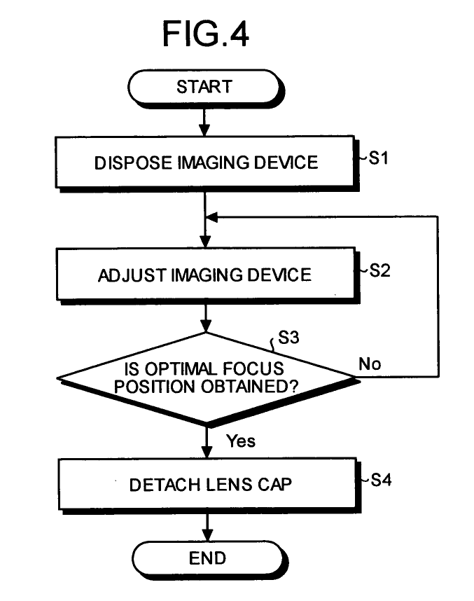

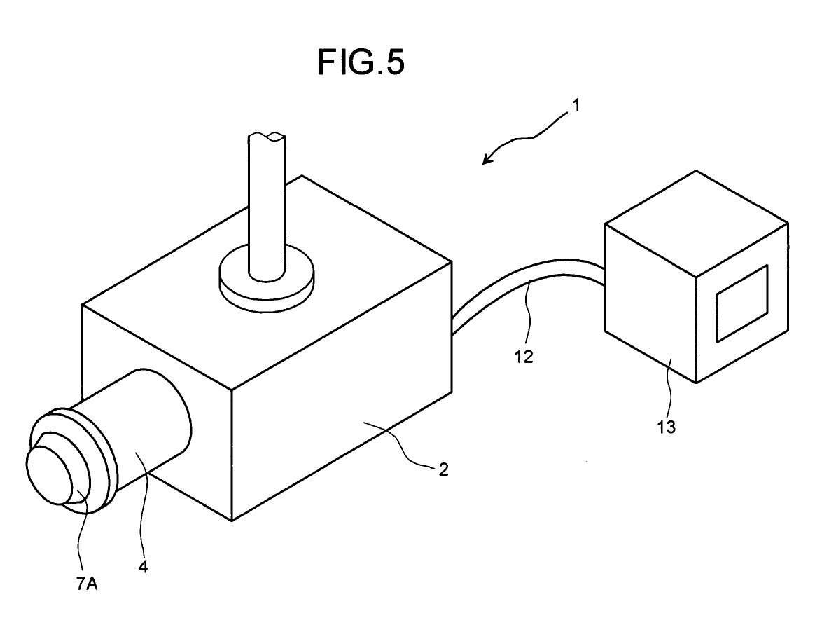

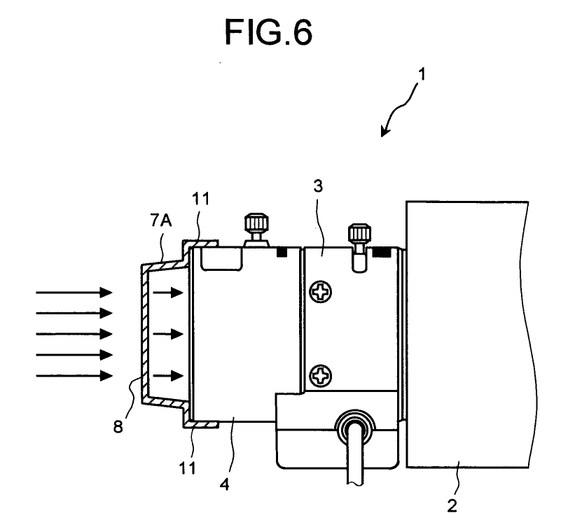

A mounting method of the imaging device 1 using the lens cap 7A of the embodiment will be explained. In this embodiment, the mounting operation of the imaging device 1 during daylight hours with the nighttime shooting in mind will be explained using FIG. 4 to FIG. 6. FIG. 4 is a flowchart illustrating a procedure of this method. FIG. 5 illustrates a mounted state of the imaging device when the lens cap 7A is used. FIG. 6 is a partial side view of the imaging device 1 on which the lens cap 7A is mounted.

First, as illustrated in FIG. 4, the imaging device 1 to which the lens cap 7A is previously mounted is disposed on an intended place (step S1). At that time, the imaging device 1 is connected to a monitor 13 through a cable 12 as illustrated in FIG. 4. Since the lens cap 7A is mounted on the tip end 5 of the lens-barrel 4 as illustrated in FIG. 6, a portion of incident light into the imaging device 1 passes through the cap surface 8 and the remainder is reflected without passing through the cap surface 8. Accordingly, the incident light quantity is attenuated, and the quantity incident light into the imaging device 1 is adjusted to the equal light quantity at the time of the nighttime shooting.

When the lens cap 7A is held to be mounted on the tip end 5 of the lens-barrel 4, the imaging device 1 is adjusted (step S2). More concretely, the focus of the shooting lens of the imaging device 1 is adjusted and the aperture diameter of the auto iris 3 is adjusted such that an optimal image can be obtained when the lens cap 7A is held to be mounted on the tip end 5 of the lens-barrel 4.

When an image (picture) indicated on the monitor 13 is out of optimal focus for carrying out the nighttime shooting using the imaging device 1 (No in step S3), since the optimal depth of field could not obtained, the imaging device 1 is adjusted again (step S2).

On the other hand, if the optimal focus position is obtained (Yes in step S3), since the optimal depth of field is obtained, the lens cap 7A is detached from the tip end 5 of the lens-barrel 4 (step S4). With this configuration, the mounting operation and the adjustment operation of the imaging device 1 with the nighttime shooting in mind are completed. Thereafter, if it is detached from the tip end 5 of the lens-barrel 4, the imaging device 1 can be used. If the lens cap 7A is made of synthetic resin, the cap can be produced inexpensively and thus, the cap may be disposed of.

In this embodiment, the quantity of incident light to the imaging device 1 can be adjusted only by disposing the imaging device 1 on which the lens cap 7A is mounted, and the focus can be adjusted with the nighttime shooting in mind even when the imaging device 1 is mounted during the daylight hours.

In the embodiment, since the lens cap 7A is used as the light quantity adjustment cover 7, it is easy to attach and detach the lens cap 7A to and from the tip end 5 of the lens-barrel 4 of the imaging device 1. Thus, if this lens cap 7A is previously mounted to the tip end 5 of the lens-barrel 4 of the imaging device 1 before the imaging device 1 is disposed, the shooting lens can be protected when the imaging device 1 is transferred to a mounting position.

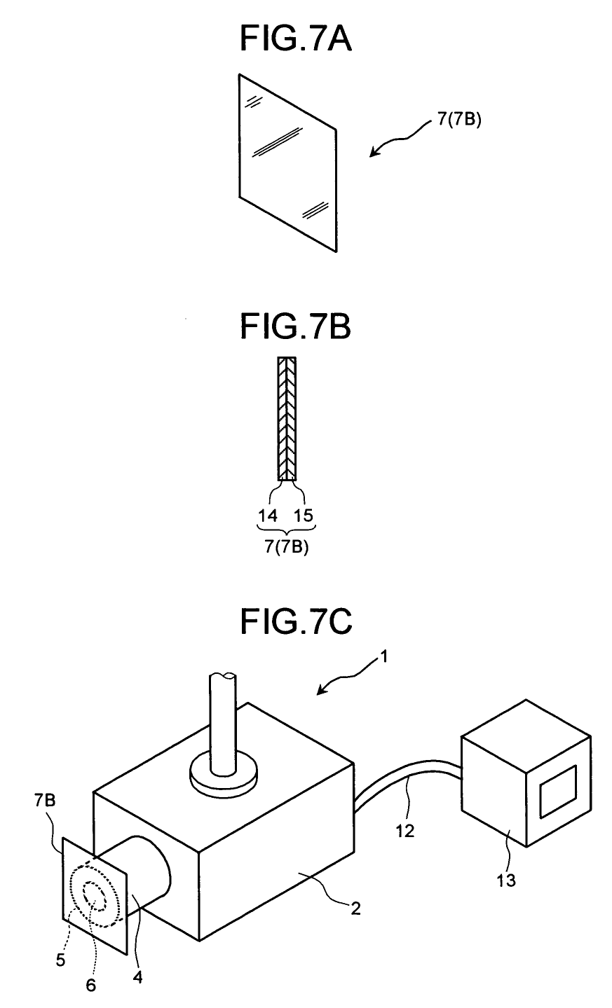

Although the lens cap 7A is explained as the light quantity adjustment cover 7 which can be attached to and detached from the tip end 5 of the lens-barrel 4, but a pasting sheet 7B may be used as the light quantity adjustment cover 7 as illustrated in FIG. 7A. In this case, as illustrated in FIG. 7B, if one of surfaces of the sheet body 14 may be coated with a pasting layer 15 and the one surface is pasted on the tip end 5 of the lens-barrel 4, the light quantity can be adjusted like the lens cap 7A. Further, as illustrated in FIG. 7C, the imaging device 1 may be adjusted in such a manner that the pasting sheet 7B is pasted on the opening 5 of the lens-barrel 4 of the imaging device 1 to dispose the imaging device 1, and after the imaging device 1 is disposed, the pasting sheet 7B may be detached. If the pasting sheet 7B is made of synthetic resin, it may be disposed of as it is.

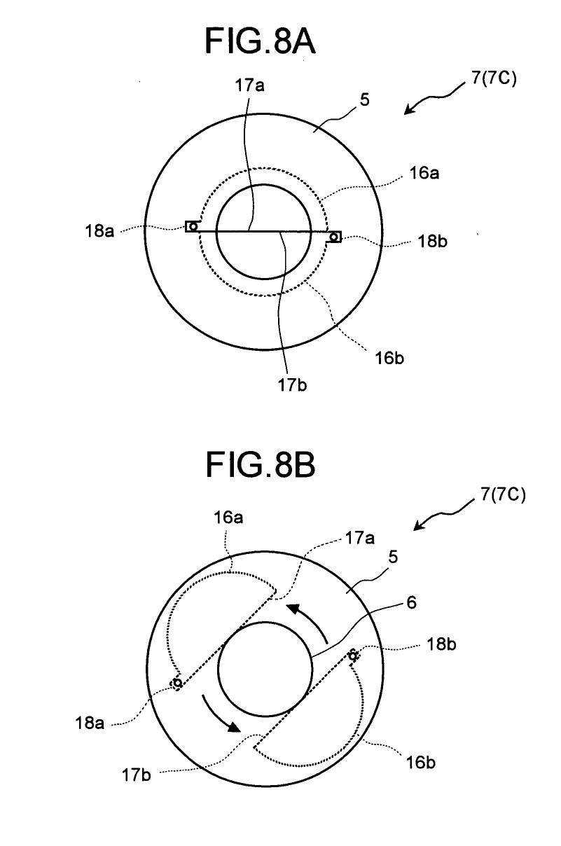

As illustrated in FIGS. 8A and 8B, as the light quantity adjustment cover 7, the incident opening 6 of light may be opened and closed by an opening/closing mechanism 7C provided in the lens-barrel 4. The opening/closing mechanism 7C includes two blade members 16a and 16b for example. Each of the blade members 16a and 16b is formed into a substantially semi-circle plate. The blade members 16a and 16b have chords 17a and 17b, and projections 18a and 18b project from opposite one ends of the chords 17a and 17b, and the projections 18a and 18b are rotatably supported in a direction perpendicular to an optical axis of the shooting lens. The blade members 16a and 16b are arranged when the chords 17a and 17b abut against each other, the opening 6 is closed as illustrated in FIG. 8A, and if the chords 17a and 17b are separated from each other, the opening 6 is opened as illustrated in FIG. 8B. This opening and closing operation can be controlled by a control unit (not illustrated).

According to this configuration, both the blade members 16a and 16b can close the opening 6 when the imaging device 1 is mounted, and the opening 6 can be opened at the time of surveillance. With this configuration, the imaging device 1 can be closed before it is mounted so that the shooting lens in the lens-barrel 4 can be protected. After the imaging device 1 is mounted, if the incident opening 6 is opened, the incident light is allowed to enter as it is and the surveillance can be conducted. Even after the opening 6 is opened, if it becomes necessary to again adjust the focus, the light quantity can easily be adjusted by closing the incident opening 6 by both the blade members 16a and 16b.

Although the opening/closing mechanism 7C includes the two blade members 16a and 16b, the number of the blade members may be one, three or more.

The object of the present invention can also be achieved by mounting a filter having the same functions as those of the lens cap 7A, the pasting sheet 7B, and the opening/closing mechanism 7C instead of using these elements. However, such a filter is unnecessary when the imaging device 1 is operated, the filter must easily be detached. The filter may slide and come out from an optical path of the shooting lens when the imaging device 1 is operated. An ND filter can be used as such a filter. In this case, a density of the ND filter can variously be selected from ND1 to ND95.

As explained above, only by mounting the light quantity adjustment cover 7 of the invention on the tip end 5 of the lens-barrel 4, it is possible to suppress the incident light quantity to the shooting lens of the imaging device 1, and to create the same environment as the nighttime shooting. Thus, it is possible to easily mount the imaging device 1 and adjust the focus with the nighttime shooting in mind even during the bright daylight hours only by carrying out the procedures of steps S1 to S4 illustrated in FIG. 4. With this configuration, out-of-focus of the shooting lens during the nighttime shooting can be prevented, and it is unnecessary to again request the mounting operator to adjust the focus, the efficiency of mounting operation can be enhanced, a user can optimally operate the imaging device 1 on the same day when the imaging device 1 is mounted, and crime prevention can be enhanced.

Although the focus of the imaging device 1 is manually adjusted in the above embodiment, diaphragm of the imaging device 1 may be manually adjusted. With this configuration, it is possible to adjust the diaphragm at a time like the focus adjustment, and the efficiency of the mounting operation of the imaging device is enhanced. Further, the imaging device can easily and simply be mounted irrespective of the degree of skill of the mounting operator.

According to the arrangement of the present invention the imaging device can be mounted easily and efficiently.

The present document incorporates by reference the entire contents of Japanese priority document, 2002-368978 filed in Japan on Dec. 19, 2002.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A light quantity adjustment cover, comprising an arrangement with which a quantity of incident light to an imaging device can be adjusted when the imaging device is set.

2. The light quantity adjustment cover according to claim 1, wherein the light quantity adjustment cover is made of synthetic resin.

3. The light quantity adjustment cover according to claim 1, wherein the light quantity adjustment cover can be attached to and detached from the imaging device.

4. The light quantity adjustment cover according to claim 1, wherein the light quantity adjustment cover can open and close an incident opening of light to the imaging device.

5. An imaging device, comprising a light quantity adjustment cover fit to an opening from where light enters into the imaging device, wherein the light quantity adjustment cover includes an arrangement with which a quantity of light entering into the imaging device can be adjusted when the imaging device is set.

6. The imaging device according to claim 5, wherein the imaging device is used for surveillance.

7. The imaging device according to claim 5, wherein the opening is an opening of a lens-barrel which holds a shooting lens, the light quantity adjustment cover is fit to the opening such as to cover the shooting lens.

8. The imaging device according to claim 6, wherein the imaging device is used for surveillance.

9. An imaging device mounting method of mounting an imaging device, wherein in the imaging device a quantity of incident light into the imaging device can be adjusted by means of a light quantity adjustment cover, comprising adjusting the quantity of incident light into the imaging device by adjusting at least either of diaphragm or filter of the imaging device.

10. The method according to claim 9, wherein when the quantity of incident light into the imaging device is adjusted using the light quantity adjustment cover, further comprising, after the adjustment either of the diaphragm or the filter, detaching the light quantity adjustment cover to thereby release the adjustment of light quantity.
